(19) United States
(12) Patent Application Publication
(10) Pub. No.: US 2009/0040132 A1
(43) Pub. Date: Feb. 12, 2009

(54) Anisotropic metal-dielectric metamaterials for broadband all-angle negative refraction and superlens imaging

(75) Inventors: Srinivas Sridhar, Newton, MA (US); Wentao Lu, Malden, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Northeastern University, Boston, MA (US)

(21) Appl. No.: 12/220,445

(22) Filed: Jul. 24, 2008

Related U.S. Application Data
(60) Provisional application No. 60/961,831, filed on Jul. 24, 2007.

(51) Int. Cl. H01Q 15/08; B05D 1/12

(52) U.S. Cl. 343/911 R; 427/180; 977/762; 977/742

(57) ABSTRACT

A metamaterial comprises a plurality of metallic nanowires embedded in a dielectric matrix. The metamaterial composite media provide broadband all-angle negative refraction and flat lens, superlens and curved hyperlens imaging in specific spectral regions over a wide range of frequencies including, for example, from deep infrared to ultraviolet frequencies.

### CROSS REFERENCE TO RELATED APPLICATIONS

This application claims the benefit of U.S. Provisional Application No. 60/961,831, entitled “Anistropic Metal-Dielectric Metamaterials for Broadband All-Angle Negative Refraction and Flat Lens Imaging” filed Jul. 24, 2007, the entire teachings of which are incorporated herein by reference.

### STATEMENT REGARDING FEDERALLY SPONSORED RESEARCH OR DEVELOPMENT

This work was supported by the Air Force Research Laboratories, Hanscom through FA8718-06-C-0045 and the National Science Foundation through PHY-0457002.

### BACKGROUND OF THE INVENTION

Since the demonstration of negative refraction in microwave frequencies, the need for possible applications in optics has pushed the phenomenon to visible frequencies. Perhaps the most prominent application is the concept of the perfect lens that will break the diffraction limit. So far, negative refraction is realized only in periodic or quasi-periodic structures such as metamaterials and photonic crystals. As the frequency is increased, the wavelength becomes smaller, and thus so does the required unit cell size. This puts a tremendous strain on the design and fabrication of suitable negative refraction materials.

To date, the approaches for negative refraction and all-angle negative refraction in the optical range have required sophisticated structures to be fabricated. Even if made possible, such materials are lossy and typically narrowband.

### SUMMARY OF THE INVENTION

According to one aspect of the invention, a metamaterial comprises a plurality of metallic nanowires embedded in a dielectric matrix. The metamaterial composite media of the invention provide broadband all-angle negative refraction and flat lens and superlens imaging over a wide range of frequencies including, for example, from deep infrared to ultraviolet frequencies.

For applications in the infrared range, for example, copper and gold nanowires can be used. Metallic semiconductor nanowires can also be used. For applications in the near infrared and visible range, for example, silver nanowires can be used. For applications in the ultraviolet range, for example, free-standing aluminum nanowires are preferably utilized.

The composite anistropic media of the invention includes two surface plasmon resonances (SPR): a longitudinal SPR and a transverse SPR. The longitudinal SPR generally has a longer wavelength than the transverse SPR. The smaller the dielectric constant of the host material, the shorter the longitudinal SPR wavelength.

For wavelengths longer than the longitudinal SPR, the composite medium has a negative group refractive index, which enables flat lens imaging. In certain embodiments, the metamaterials of the invention can be used for superlens and hyperlens imaging.

The loss in the composite media can be tailored by choice of constituent materials, particularly the host medium, and the proportions of materials in the composite media.

The metamaterials of the invention can be fabricated using a variety of processes, including both top-down lithography and bottom-up assembly methods. In general, it is not necessary to have a dielectric matrix. For the bottom-up assembly method, it is normally required to have a dielectric matrix to support the nanowires. Even when the dielectric matrix other than air is necessary, other dielectrics, such as porous silicon, or porous titania, can be used as the matrix.

The embedded nanowires can also be carbon nanotubes, or metallic semiconductors. The metamaterials will be operated in the windows of anomalous dispersion of the nanotubes or nanowires.

If the surface is flat, the metamaterial can be used as a flat lens or a superlens. If the surface is curved, it can be used as a hyperlens.

The metamaterials of the present invention provide new and simpler structures for negative refraction and its application in the infrared and the visible range. The invention further enables negative refraction applications in the ultraviolet range. The present metamaterials are easy to fabricate, and the loss can be easily tailored.

The metamaterials of the invention provide negative refraction and flat lens imaging up to the ultraviolet range, which is of tremendous importance for photolithography applications. Furthermore, the present metamaterials include numerous applications for imaging and sensor systems, can be integrated into optical circuits for telecommunications devices, and can also be useful for bio-sensor applications.

### BRIEF DESCRIPTION OF THE DRAWINGS

FIG. 1 is a perspective view of a slab of a composite material comprising a plurality of cylindrical metal rods or wires embedded in a dielectric host medium;

FIGS. 2A-2C are plots showing the effective permittivities and absorption spectra for composite media with embedded silver (Ag), gold (Au) and aluminum (Al) nanowires;

FIGS. 3A and 3B are illustrations of negative refraction and superlens imaging of P-polarized waves by a slab of indefinite medium with Re ε_{z}<0 and Re εₓ>0;

FIG. 4A illustrates the imaging by a superlens with εₓ=1.301+0.010i, ε_{z}=−0.647+0.258i and thickness d=0.7 μm at λ=326.3 nm;

FIG. 4B is a plot of the lens property σ and n_{eff} as functions of the incident angle for the superlens of FIG. 4A;

FIG. 5A is a scanning electron microscopy (SEM) image showing Au nanowires with diameter 10-12 nm embedded inside alumina;

FIG. 5B is a SEM image showing 10-12 nm diameter Au nanowires sticking out of an etched alumina template;

FIG. 6A illustrates transmission spectra for 12±2 nm diameter Ag nanowires in porous alumina for varying angles of incidence φ and with P-polarization. A solid curve illustrates S-polarization and φ=40 deg.;

FIG. 6B illustrates absorbance spectra for the Ag nanowires of FIG. 6A;

FIG. 6C illustrates anisotropic permittivity of the Ag nanowires in alumina with K1=0.75, κ_{∥}=95 and the filling ratio f=0.055;

FIG. 6D illustrates calculated absorbance of Ag nanotemplate with d₁=2.9 μm and d₂=1.1 μm.

FIG. 7A illustrates transmission spectra for 12±2 nm diameter Au nanowires in porous alumina for varying angles of incidence φ and with P-polarization. A solid curve illustrates S-polarization and φ=40 deg.;

FIG. 7B illustrates absorbance spectra for the Au nanowires of FIG. 7A;

FIG. 7C illustrates anisotropic permittivity of the Au nanowires in alumina with K1=0.85, κ_{∥}=60 and the filling ratio f=0.04; and

FIG. 7D illustrates calculated absorbance of Au nanotemplate with d₁=3.5 μm and d₂=0.5 μm.

### DETAILED DESCRIPTION OF THE INVENTION

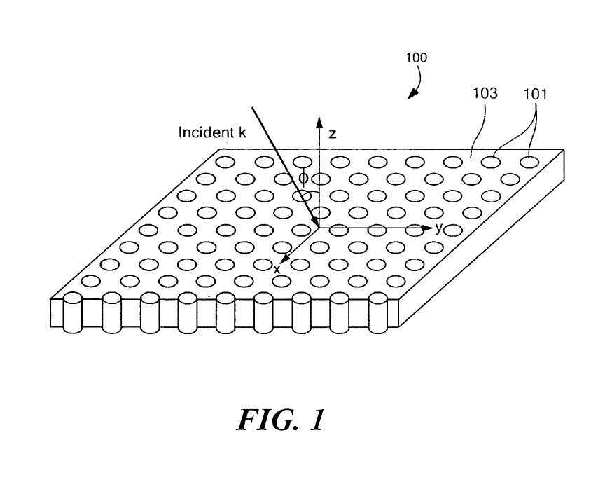

FIG. 1 illustrates a slab of a composite material 100 comprising a plurality of cylindrical metal rods or wires 101 embedded in a dielectric host medium 103. Using the effective medium theory (EMT), the optical properties of a composite metal-dielectric structure can be modeled. These anisotropic media have two surface plasmon resonances (SPR): a longitudinal SPR and a transverse SPR. For wavelength larger than that of the longitudinal SPR, these media are negative index metamaterials and can be used for flat lens and superlens imaging in the frequency range from the deep-infrared to the ultraviolet. Negative refraction and superlens imaging are possible due to the anisotropic optical properties. These structures do not need to be periodic. Disordered systems can also be used for negative refraction.

Considering a metal with Re εₘ<0 embedded in an ambient medium with positive εₐ. In the long wavelength limit, one has the Bruggeman's EMT:

$$0 = f \frac{{ɛ}_{m} - {ɛ}_{eff}}{{ɛ}_{m} + D {ɛ}_{eff}} + ( 1 - f ) \frac{{ɛ}_{a} - {ɛ}_{eff}}{{ɛ}_{a} + D {ɛ}_{eff}} \qquad ( 1 )$$

Here, f is the metal filling ratio, D=measure of the aspect ratio of the metal inclusions, εₐ=permittivity of the dielectric, εₘ=permittivity of the wires and ε_{eff}=effective permittivity of composite structure. The solution is:

$${ɛ}_{eff} ( D ) = \frac{1}{2 D} ( Δ \pm \sqrt{{Δ}^{2} + 4 D {ɛ}_{a} {ɛ}_{m}} ) \qquad ( 2 )$$

with Δ=f(1+D)(εₘ−εₐ)+κDεₐ−εₘ. The sign is chosen such that Im ε_{eff}>0. For sphere inclusion, one has D=2. For slab inclusion, D=0 and ∞ for the effective permittivity perpendicular and parallel to the slabs, respectively.

For cylindrical inclusions with the cylindrical axis in the z direction, as shown in FIG. 1, one has:

εₓ=ε_{y}=ε_{eff}(1).

ε_{z}=ε_{eff}(∞)=fεₘ+(1−f)εₐ. (3)

From this expression, one can see that there exists a minimum filling ratio:

fₘᵢₙ=εₐ/(εₐ−Reεₘ) (4)

such that for f>fₘᵢₙ, Reε_{z}<0 and for f>½, Reε_{x,y}<0. If one desires Re ε_{x,y}>0 but Re ε_{z}<0, one should have Re εₘ<−εₐ so that fₘᵢₙ<½. It is noted that for the modeling of real systems, the value of D can be different from those used here.

The physical meaning of fₘᵢₙ is the following. At this filling ratio, which also corresponds to a fixed frequency of wavelength λₗ since εₘ is dispersive, the composite medium has Re ε_{z}=0, which gives strong absorption of the medium since Imk_{z} will have a peak for any nonzero kₓ. This frequency corresponds to the longitudinal SPR. For example, for a Drude metal with εₘ=1−λ²/λₚ² and λₚ the plasmon wavelength, one has λₗ=λₚ[1+(f⁻¹−1)εₐ]^{1/2}. Thus, λₗ is very sensitive to the filling ratio, f, and the dielectric constant of the host medium εₐ. This increase of the filling ratio results in a blue-shift of the longitudinal SPR. The smaller the refractive index of the host medium, the shorter the longitudinal SPR λₗ. High absorption is also expected for frequency at the so-called transverse SPR, which is located around the surface plasmon wavelength λₛₚ (Re εₘ=−εₐ) and has a very weak dependence on the filling ratio. For a Drude metal, there is a frequency range λ_{l,+}<λ<λ_{l,-} with εₘ(λ_{l,±})=εₐ{1−2(1−2f)⁻²±4[f(1−f)]^{1/2}(1−2f)⁻²} such that Im εₓ>0, and the medium shows strong absorption. Here εₘ(λ_{l,+})>−εₐ and εₘ(λ_{l,-})<−εₐ. For f<0.1464, one has λ_{l.-}<λₗ.

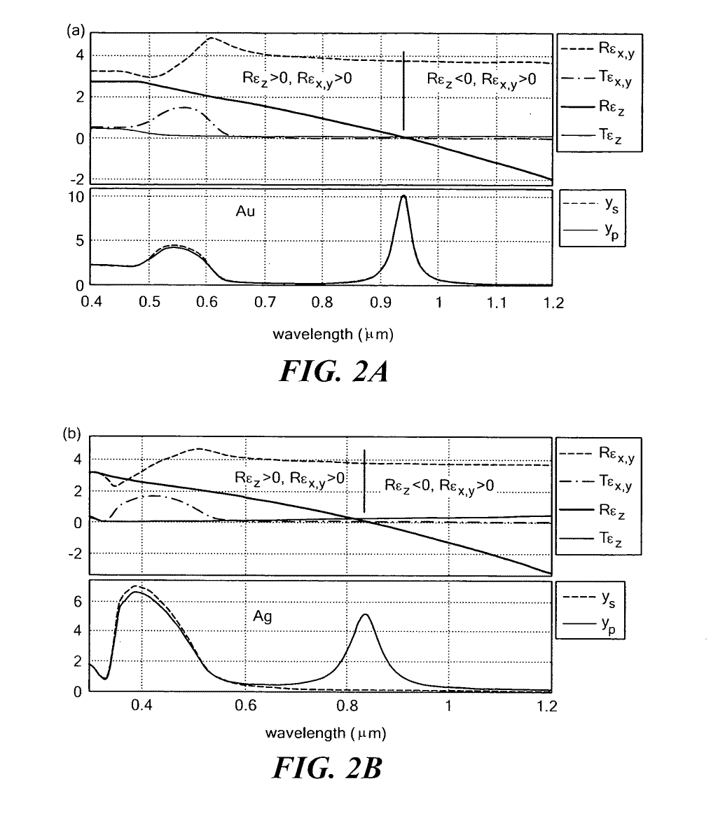

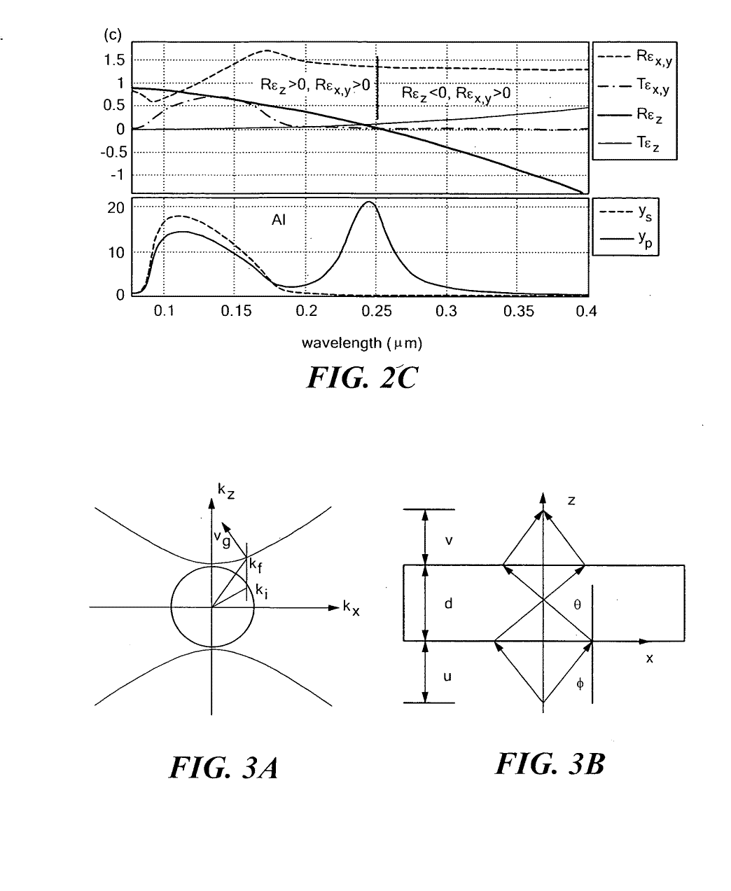

For composite media with embedded silver (Ag), gold (Au) and aluminum (Al) nanowires, the effective permittivities and absorption spectra y=ln[(1−R)/T] are calculated and shown in FIGS. 2A-2C. Here R and T are the reflection and transmission intensities of waves through a slab. In FIG. 2A, 8% gold nanowires are embedded in an alumina template; in FIG. 2B, 8% silver nanowires are embedded in an alumina template; and in FIG. 2C, 10% aluminum nanowires are in air. The thicknesses of the metamaterials are all 500 nm. The S- and P-polarized waves have an incident angle of 25°. The optical constants are taken from J. H. Weaver et al., Optical Properties of Metals (Fachinformationszentrum, Karlsruhe, Germany, 1981), and are fitted with polynomials. The absorption spectra clearly show the longitudinal SPRs for the P-polarized waves.

When the metamaterial has Re ε_{z}<0 and Re ε_{x,y}>0, this so-called indefinite medium has unusual wave refraction phenomena and can be used for negative refraction (NR) and superlens imaging for incident waves along the nanowire axis. A slab of such material whose surface is along the x axis and surface normal is along the z axis is illustrated schematically in FIG. 3B. The relative permeability is assumed to be unity. For the P polarization with the magnetic field in the y direction and the electric field in the xz plane, the dispersion is k_{z}²=εₓk₀²−εₓkₓ²/ε_{z}. Here k₀=2π/λ the wave number in free space. When Re ε_{z}<0 and Re ε_{x,y}>0, the equifrequency surface (EFS) is hyperbolic instead of elliptic as shown in FIG. 3A. For this medium, it is more meaningful to discuss the energy flow. The group velocity refraction is governed by

tan θ=−σ tan φ (5)

Here φ is the angle for the incident group velocity and θ is that for the refracted group velocity (see FIG. 3B). The material property, σ, is defined and evaluated as:

$$σ ≡ \frac{d {k}_{z}}{d {k}_{0 z}} = - \frac{\sqrt{{ɛ}_{x}}}{{ɛ}_{z}} \frac{\sqrt{{k}_{0}^{2} - {k}_{x}^{2}}}{\sqrt{{k}_{0}^{2} - {k}_{x}^{2} / {ɛ}_{z}}} \qquad ( 6 )$$

Here k_{0z}=\sqrt{k₀²−kₓ²}. At λ>λ₁, one has σ>0 for all propagating waves, thus all-angle negative refraction (AANR) can be realized in this medium. For small kₓ, the EFS can be approximated by k_{z}≅κ−σ₀k_{0z}with σ₀=−\sqrt{εₓ}/ε_{z}>0, and κ=\sqrt{εₓ}k₀(1−1/ε_{z}). A slab of this material with thickness d can be used as a flat lens with the lens equation μ+vν=σ₀d. Since a is not a constant, caustics will be present in the image. However, an effective 0<σ_{eff}<σ₀ can be obtained for this lens. The group refractive index n_{eff} is related to σ through n_{eff} sin θ=sin φ. One has n_{eff}˜−σ⁻¹.

There are two strategies to realize Re ε_{z}<0 and Re εₓ>0. For spherical embedment, the composite medium is isotropic which is generally not suitable for negative refraction if no magnetic material is used. A cylinder or slab inclusion will provide the desired property. For the frequency lower than that of SPR where Re εₘ=−εₐ, the cylinder axis should be along the z-direction, as previously discussed. For frequency higher than that of SPR but lower than the plasmon frequency where Re εₘ=0, the cylinder axis should be in the xy plane. If one considers the cylinder axis to be along the x-axis, then εₓ=fεₘ+(1−f)εₐ and

$${ɛ}_{y} = {ɛ}_{z} = \frac{1}{2} [ Δ \pm {( {Δ}^{2} + 4 {ɛ}_{a} {ɛ}_{m} )}^{1 / 2} ] .$$

Since for these frequencies, −εₐ<Re εₘ<0, one should have a lower and upper bound for the filling ratio as fₘᵢₙ=½ and fₘₐₓ=εₐ/(εₐ−Re εₘ), respectively. These structures suffer a drawback that the wave phenomena for negative refraction should be limited to the xz-plane since ε_{y} has the same value as ε_{z}.

Note that the above metamaterials do not support surface waves. The enhancement of subwavelength imaging resolution is limited. However, if the lens is curved, one can use it as a magnifying hyperlens. The metamaterials can be either metallic nanowires embedded in a dielectric matrix or metallic film with holes filled with dielectrics including air. These media can be used for negative refraction and flat lens imaging in three-dimensional free space. The currently studied multilayered structures for negative refraction, superlens and hyperlens are two-dimensional reductions of theses structures. The filling ratio of f=½ is special for multilayered metal-dielectric structures. At this filling ratio, Re εₓ and Re ε_{z} will always have the opposite signs. This can be utilized to realize a magnifying hyperlens.

Anistropic metamaterials with embedded Au, Ag and Al nanowires can be used for flat lens imaging in the infrared, visible and ultraviolet, respectively. For example, for gold at λ=1.55 μm, one has εₘ=−104.2+3.59i. Here one can use εₐ=2.89 for alumina in the infrared and the visible range. With a 5% filling ratio, ε_{z}=−2.42+0.19i and εₓ=3.23+0.001i. Thus, σ₀=0.74. The permittivity of gold is taken from Weaver, supra. For this filling ratio, negative refraction and flat lens imaging can be realized for the wavelength λ>1.15 μm. For Ag at λ=833 nm, εₘ=−33.5+3.14i. A filling ratio f=0.1 of silver in alumina template will have εₓ=3.826+0.025i and ε_{z}=−0.749+0.314i. For this lens, σ₀=2.2 and the thickness of the lens can be up to 20 μm. For Al at λ=364.7 nm, εₘ=−19.42+3.60i. A 12% filling ratio of aluminum in a magnesium fluoride (MgF₂) matrix (εₐ=2.0) gives εₓ=2.886+0.066i and ε_{z}=−0.570+0.432i. A lens made of a flat slab of such medium has σ₀=1.88 and can have a maximum thickness of 2.98 μm.

According to another aspect, the metamaterials of the present invention can provide superlens imaging. Referring again to Equation 6, when the material property, σ, is constant, then the phase across the lens Φ_{z}=k_{0z}(u+v)+k_{z}d=κd is stationary and an image will be formed without aberration. Here u, v, and d obey the equation u+v=d (see FIG. 3B). This is the lens equation for a generalized superlens. In this case, the refractive index n_{eff} is angle dependent, and one can achieve “perfect focusing” without an optical axis, as discussed in W. T. Lu and S. Sridhar, “Flat Lens Without Optical Axis: Theory of Imaging,” Opt. Express 13, pp. 10673-10680 (2005), the entire contents of which are incorporated herein by reference. It should be noted that the Veselago lens has σ=1, where the EFS is circular.

In the present anisotropic material, σ is angle dependent and not a constant because the EFS is hyperbolic and not elliptic, hence the lens has caustics and the image is not “perfect.” Nevertheless, a high quality image can be formed by the lens with u+ν=σ_{eff}d and σ_{eff}<σ₀. Furthermore, although the nonlocal effect on effective permittivity indicates the limitation of Bruggeman's EMT, it will render the EFS to be more elliptic than hyperbolic. Thus, it can reduce the caustics.

The present composite medium with cylindrical inclusion can be used for NR and superlens imaging in three-dimensional free space for frequencies below the surface plasmon frequency. These metamaterials do not support surface waves. The enhancement of subwavelength imaging resolution is still possible. If the lens is curved, one may be able to use it as a magnifying hyperlens. The currently known multilayered structures for NR, superlens and hyperlens are two-dimensional reductions of these structures. The filling ratio f=½ is special for multilayered metal-dielectric structures. At this filling ratio, Re εₓ and Re ε_{z} will always have the opposite signs. This has been utilized to realize a magnifying hyperlens. Naturally available anisotropic dielectric crystals may be used to achieve NR, but cannot be used for superlens imaging.

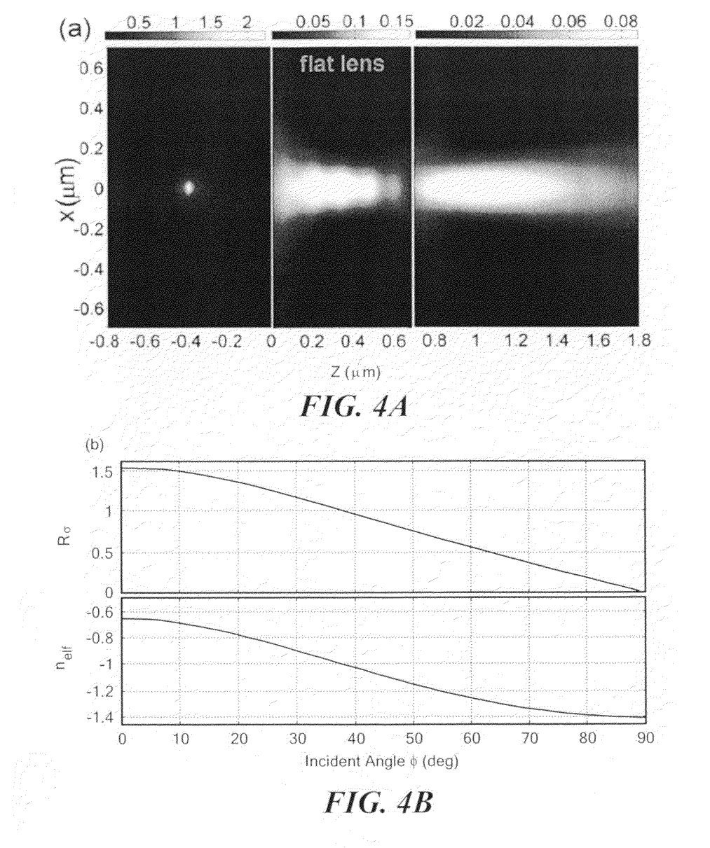

Anisotropic metamaterials with embedded Au, Ag and Al nanowires can be used for superlens imaging in the infrared, visible and ultraviolet, respectively. For example, for Al at λ=326.3 nm, εₘ=−15.468+2.575i, a 10% filling ratio of Al nanowires in air gives εₓ=1.301+0.010i and ε_{z}=−0.647+0.258i. A lens made of a flat slab of such a medium has σ₀=1.52 and can have a maximum thickness of 11.9 μm. The imaging effect of a point source of such a medium is shown in FIG. 4A. In FIG. 4A, the thickness, d, is 0.7 μm, the point source is at u=0.40 μm and a focus is obtained at v=0.30 μm. The lens has σ_{eff}=1.00. Plotted is the intensity of the magnetic field, which is in the y direction. Evanescent waves of the source are included up to kₓ/k₀=3. In FIG. 4B, the lens property σ and n_{eff} are plotted as functions of the incident angle. The angle-dependent lens property as shown in FIG. 4B leads to the presence of caustics, which can be reduced if multiple lenses are used.

For the propagating waves within the xy plane, NR and superlens imaging can be realized in a finite slab of such an anisotropic medium. In this case, for the P-polarized waves, kₓ=\sqrt{ε_{z}}\sqrt{k₀²−k_{z}²/εₓ}. For λ>λ₁, Re ε_{z}<0, a free-suspending slab will support guided waves in the xy plane if \sqrt{Reεₓ}>1 and k_{z}>\sqrt{Reεₓ}k₀. These guided waves are backward waves with Re kₓ<0. In this geometry, surface waves can be formed, which can lead to subwavelength imaging resolution. There is no need to sandwich this medium by perfect conductor waveguide plates.

For the S polarization, the medium with cylinder inclusion is isotropic with positive effective permittivity. The dispersion is given by k_{z}²=ε_{y}k₀²−kₓ². No NR can be realized for this polarization.

There are two strategies to realize Re ε_{z}<0 and Re εₓ>0, depending on the wavelength λ>λₛₚ or λ<λₛₚ. Sphere inclusion will lead to isotropic permittivity. However, cylinder or slab inclusion will provide the desired anisotropy. For λ>λₛₚ, the cylinder axis should be along the z axis, as previously discussed. The slab inclusion can be realized as a metallic grating. In such a case, Re ε_{y,z}<0 and Re εₓ>0. Though loss is low in εₓ, NR is limited to the xz plane. EMT theory gives a very simple explanation for the broadband AANR in the metallic grating. Furthermore, the EMT is more accurate than the coupled-wave theory. In addition, numerical simulations indicate that AANR does not require the metallic grating to be periodic.

For λₚ<λ<λₛₚ, indefinite medium can be realized if the cylinder axis is in the xy plane for the cylinder inclusion. If the cylinder axis is along the x axis, εₓ=ε_{eff}(∞) and ε_{y,z}=ε_{eff}(1). For these wavelengths −ε_{z}<Re εₘ<0, one should have ½<f<εₐ/(εₐ−Re εₘ) high loss will be expected for εₓ. However, the slab inclusion, which is exemplified by multilayered metal-dielectric structures, will have ε_{y,z}<0 and Re εₓ>0 for −εₘ/(εₐ−Re εₘ)<f<εₐ/(εₐ−Re εₘ) with low loss. For these structures, Bruggeman's EMT may not be very precise to calculate effective permittivity, but the present imaging theory indicates that they are able to focus.

To demonstrate a negative index metamaterial, a versatile bottom-up nanofabrication approach has been used to prepare a high-aspect ratio metal nanowire array embedded in a dielectric aluminum oxide matrix. Such a metal-dielectric nanocomposite structure exhibits both longitudinal and transverse surface plasmon resonance modes in the absorbance as demonstrated in optical transmission measurements. The peak intensity and position of the resonances are found to depend strongly on nanocomposite parameters, incident polarization and incident angle, consistent with modeling results based on the effective medium theory. Negative refraction and superlens imaging can be realized in such structures in either the parallel or perpendicular orientations of the incident radiation with respect to axis of the nanowires. However, specific wavelength regimes are dictated by the position of the plasmon modes. Specifically, for large aspect ratio, e.g., length/diameter ˜10³, of the nanowires and small filling factors, e.g., (metal volume)/(dielectric volume) ˜10⁻¹, negative refraction can occur at visible and near-infrared wavelengths. Structures with such parameters are easily constructed using the present nanofabrication approach.

According to one embodiment, the nanowires are synthesized inside nanoporous aluminum oxide films making a uniform array of vertical nanowires arranged parallel to each other. The fabrication method allows for the preparation of nanowires with small diameters (d≦˜10 nm) and large lengths (1>˜2 μm), in effect, nanowires with large aspect ratio (l/d ˜10³). The optical absorbance is calculated from transmission measurements. The optical absorbance can be modeled by taking into account the plasmonic interaction between the metal nanowire and the aluminum oxide, where the filling factor of the metal inside the dielectric aluminum oxide and the aspect ratio of the nanowires are the main fitting parameters.

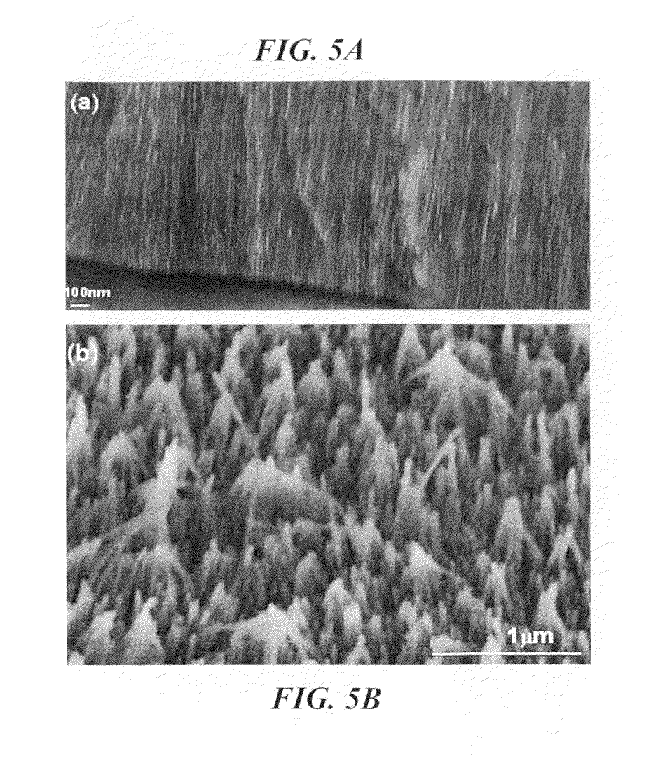

According to one example, nanoporous aluminum oxide templates were first generated by dc anodization of commercially available Al foil in an acidic electrolyte. The pore diameter of the templates can be controlled by adjusting the fabrication parameters—most importantly the acid used and the applied dc voltage. In this example, templates with two different pore diameters were fabricated. Templates with pore diameter ˜12 nm were fabricated by anodization in 15% sulfuric acid at 10V and templates with pore diameter ˜35 nm were fabricated by anodization in 3% oxalic acid at 40V. The pore patterns were quasi-ordered and uniform. The time of anodization was adjusted to produce templates with large thickness (and correspondingly large pore lengths) of ˜4 microns. Below the porous layer was a thin barrier layer of aluminum oxide (-tens of nanometers) followed by the remaining unanodized aluminum. The nanowires were synthesized inside the templates by means of ac electrodeposition (20V, 250 Hz). In the case of Au, an aqueous solution consisting of HAuCl₄ (1 g/l) and boric acid (4 g/l) was used as electrolyte. For Ag nanowires, an aqueous solution containing AgNO₃ (1 g/l) was used as electrolyte. The unanodized Al layer below the pores was removed in mercuric chloride solution. This leaves behind a dielectric template consisting of embedded Au or Ag nanowires. FIGS. 5A and 5B show typical scanning electron microscopy images of aluminum oxide membrane consisting of ˜12 nm pores filled with Au wires. From the information on the wire dimensions and the pore parameters, the fill factors (ratio of metal versus dielectric) were calculated for the samples—for the wires with diameter 12 nm, the fill ratio ˜0.05 while for the wires with diameter 35 nm, the fill ratio is ˜0.20. Such templates demonstrate optical properties which have direct applications in negative refraction, as discussed below.

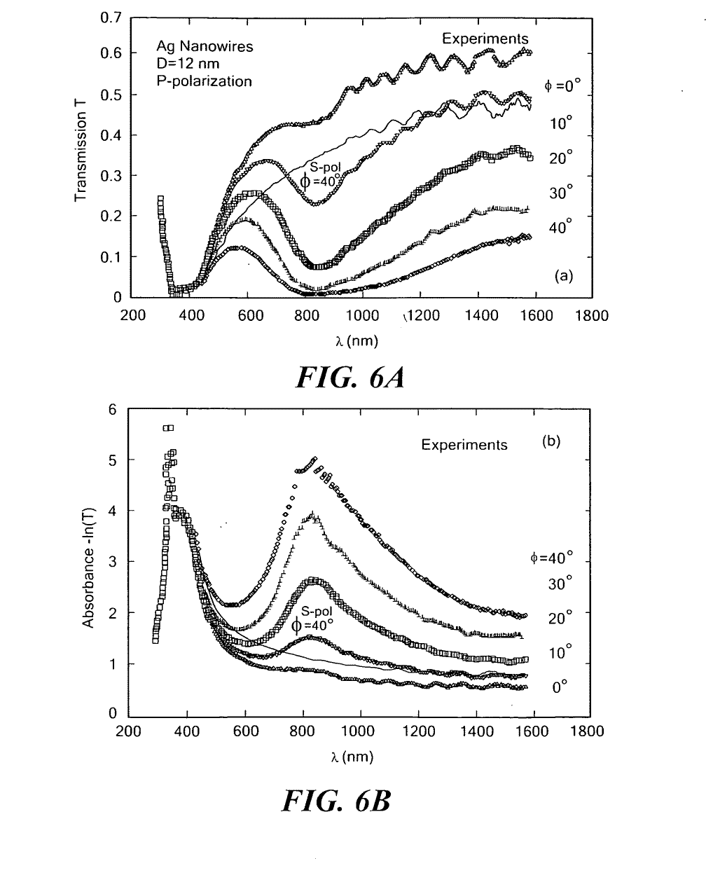

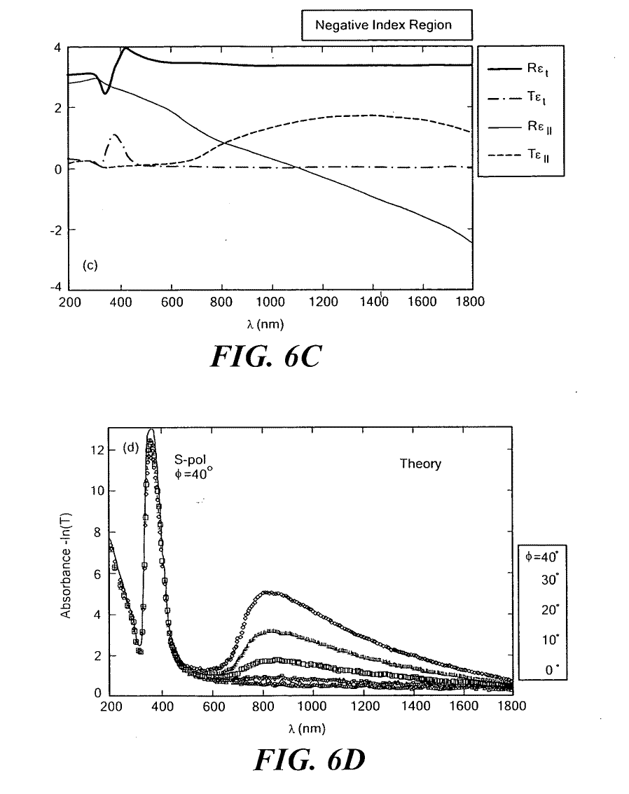

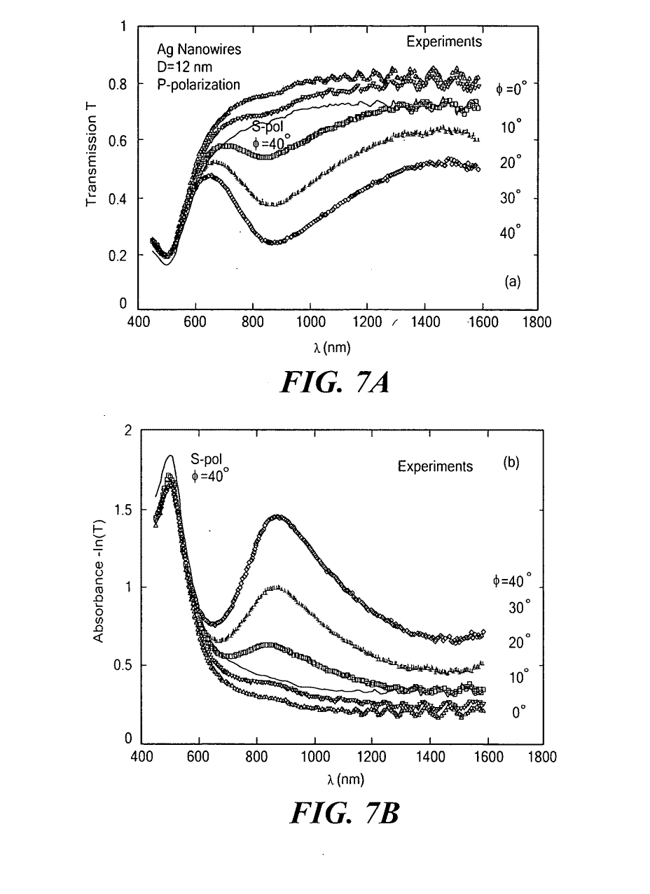

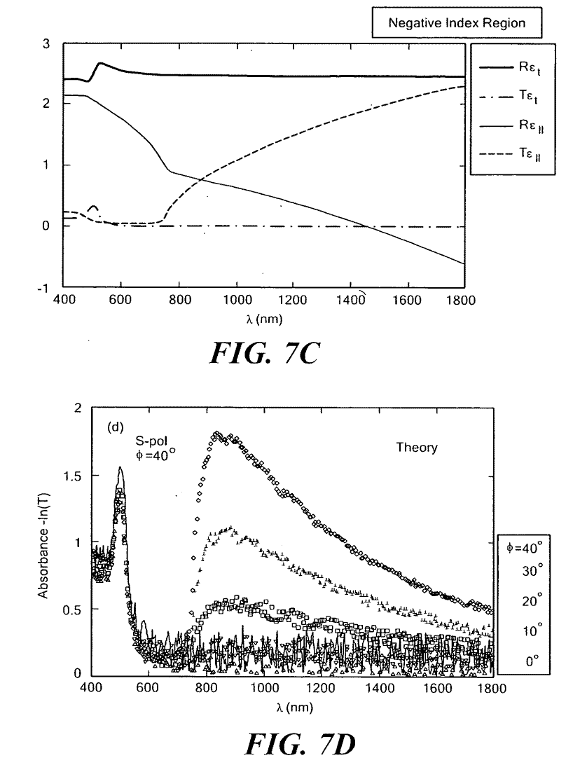

Transmission spectra for the nanowires with diameter 12 nm are shown in FIGS. 6 (for Ag nanowires) and 7 (for Au nanowires) for varying angles of incidence with respect to the long-axis of the nanowires. The spectra were obtained over the wavelength range 300-1600 nm for varying angles of incidence (φ) for both P- and S-polarized waves. For the P-polarized (S-polarized) wave, the magnetic (electric) field is perpendicular to the wire axis. A Si photodetector was used for the lower wavelength regime, 300-1000 nm, while an InGaAs photodetector was used for the higher wavelength regime, 1000-1600 nm. The optical absorbance, -ln(T), was computed from the optical transmission (T). The calculated absorbance as a function of wavelength are also shown in FIGS. 6 and 7.

The important experimental results are now discussed. For Ag nanowires, the transmission for S-polarized light has a minimum at ˜390 nm, shown in FIG. 6A for 12±2 nm diameter wires. This corresponds to an absorbance peak seen in FIG. 6B arising from the transverse plasmon mode. This transverse-related feature appears for all angles of incidence. For this S-polarization, the longitudinal plasmon mode is absent at longer wavelength. On the other hand, the P-polarized spectra show a clear absorbance peak for the longitudinal plasmon at 845 nm. The peak is absent at normal incidence but is observed to become prominent for increasing angles of incidence. The interaction of the P-polarized wave with the nanocomposite at small angles of incidence (close to the normal) is similar to the interaction of the S-polarized wave with the nanocomposite at all angles of incidence. This is expected since under these conditions the polarization axis is perpendicular to the axis of the nanowires and hence the two polarization directions are equivalent. For S-polarized waves, the nanocomposite medium is isotropic with positive effective permittivity so that the condition for the longitudinal resonance is never realized. Hence, this peak is always absent. From the model, this in turn also implies that negative refraction will not be possible under these conditions. The same explanation holds for the P-polarized waves close to normal incidence. However, for large angles of incidence of the P-polarized wave, the electric field oscillations have a component parallel to the wire axis, thus interacting with the longitudinal resonance. Thus, with increasing angle of incidence, the condition for the longitudinal resonance and consequently that for negative refraction is also met.

The corresponding modeling results for the anisotropic permittivity and absorbance are shown in FIGS. 6C and 6D. For the calculations, the same parameters were used (fill ratio, aspect ratio, etc.) corresponding to the templates studied above. Also, optical constants for Ag and aluminum oxide are taken from Weaver, supra. Comparing with the experimental results on absorbance, it is apparent that there is good agreement in peak positions and angle dependence. Also, one notes that for this sample, Reε_{∥}<0 for wavelengths λ>1100 nm. Beyond this wavelength, it will behave as a negative index material.

Similar plasmon resonances are observed for Au nanowires with wire diameter 12±2 nm as shown in FIGS. 7A and 7B. Here the transverse resonance is seen at 500 nm and is again independent of angle of incidence and polarization direction. The longitudinal resonance is strongly dependent on the incident angle and observed only for P-polarization. The longitudinal peak is in the range 845-875 nm and shows a small blue-shift for increased angle of incidence. The corresponding modeling results are shown in FIGS. 7C and 7D. As in the case of Ag, the optical constants for Au and alumina are taken from Weaver, supra. The absorbance calculations are in very good agreement with the experimental results. In this case, the sample will behave like a negative index medium for wavelength, λ>1450 nm (see FIG. 7C).

The dielectric matrix can be any-dielectric including, without limitation, alumina, titania, silicon or air. Even when the dielectric matrix other than air is necessary, other dielectrics can also be used as the matrix. That is, one may form metallic nanowires by a self-assembly process in other porous nanotemplates, such as porous silicon, or porous titania. The embedded nanowires can also be carbon nanotubes, or metallic semiconductors. The metamaterials will be operated in the windows of anomalous dispersion of the nanotubes or semiconductor nanowires. For example, one may grow silicon carbide in a porous template. According to our modeling, this metamaterial can be operated at around 11 microns.

In the negative refraction regime, optical devices, such as superlenses can be constructed utilizing such a nanocomposite structure. If the surface of the metamaterial is curved, it can be used as a hyperlens. Finally, it will be apparent that by simply adjusting the fabrication parameters, one can tailor the template parameters to tune the optical properties so that negative refraction is achieved at visible frequencies. In the presently-described fabrication approach one can easily control composite parameters to achieve the desired optical properties. Indeed, it may also be mentioned that these nanocomposite-based structures, due to their thin film nature, are easily compatible with nano- and micro-scale engineering processes making such devices practical.

In conclusion, nanocomposite structures consisting of very high aspect ratio metal nanowires embedded in dielectric have been demonstrated. Detailed transmission studies on such structures reveal the presence of two resonance peaks, the position and peak intensity of which are clearly dependent on the nanocomposite dimensions, filling ratio and the angle of incidence and polarization direction. The results are consistent with a model based on Bruggeman's effective medium theory. The nonlocal effect on the effective permittivity is small and negligible, which is confirmed by a band structure calculation. Though direct laser writing can also be used to obtain nanorod arrays, the simple fabrication approach used in the previously described example is easily amenable to varying wire dimensions, aspect ratio and fill factor to produce structures which can exhibit negative refraction in the visible wavelength regime. Such structures also demonstrate easy compatibility with micro and nanoscale engineering processes making the development of such devices feasible.

Applications for the metamaterials of the present invention include, for example, in imaging devices and waveguide devices in integrated photonics and all-optical circuits in computer chip designs in the telecommunication range. The present metamaterials can also be used to enhance high-resolution photolithography, including up to 193 nm. The present materials can also be valuable in the visible regime for biosensor applications. These metamaterials may also be used to trap light for solar cell application or as transparent electrodes.

While the invention has been described in connection with specific methods and apparatus, those skilled in the art will recognize other equivalents to the specific embodiments herein. It is to be understood that the description is by way of example and not as a limitation to the scope of the invention and these equivalents are intended to be encompassed by the claims set forth below.

What is claimed is:

1. A metamaterial comprising:
a matrix of a dielectric material; and
a plurality of metallic nanowires embedded in the matrix to form a composite material, the composite material providing a negative refraction property.

2. The metamaterial of claim 1, wherein the composite material provides a negative refraction property at an optical frequency.

3. The metamaterial of claim 2, wherein the optical frequency comprises an infrared frequency.

4. The metamaterial of claim 2, wherein the optical frequency comprises a visible light frequency.

5. The metamaterial of claim 2, wherein the optical frequency comprises an ultraviolet frequency.

6. The metamaterial of claim 1, wherein the nanowires are arranged in a substantially parallel configuration within the matrix.

7. The metamaterial of claim 1, wherein the nanowires are arranged in a substantially periodic order within the matrix.

8. The metamaterial of claim 1, wherein the nanowires are arranged in a substantially random order within the matrix.

9. The metamaterial of claim 1, wherein the nanowires comprise gold.

10. The metamaterial of claim 1, wherein the nanowires comprise silver.

11. The metamaterial of claim 1, wherein the nanowires comprise aluminum.

12. The metamaterial of claim 1, wherein the nanowires comprise copper.

13. The metamaterial of claim 1, wherein the matrix comprises aluminum oxide.

14. The metamaterial of claim 1, wherein the matrix comprises air.

15. The metamaterial of claim 1, wherein the composite material forms a flat lens.

16. The metamaterial of claim 1, wherein the composite material forms a superlens.

17. The metamaterial of claim 1, wherein the composite material forms a hyperlens.

18. The metamaterial of claim 1, wherein the ratio of the metal volume to the dielectric volume in the composite material defines a filling ratio, and the filling ratio of the composite material is on the order of 10⁻¹.

19. The metamaterial of claim 1, wherein the ratio of the length of the nanowires to the diameter of the nanowires defines an aspect ratio, and the aspect ratio of the nanowires is on the order of 10³.

20. The metamaterial of claim 1, wherein the length of the nanowires is greater than about 2 μm.

21. The metamaterial of claim 1, wherein the diameter of the nanowires is less than about 10 nm.

22. A method of manipulating optical radiation using a metamaterial, comprising:
providing a composite material comprising a plurality of metallic nanowires embedded in a dielectric matrix; and
directing optical radiation at the composite material to provide negative refraction of the optical radiation.

23. The method of claim 22, wherein the optical radiation comprises infrared radiation.

24. The method of claim 22, wherein the optical radiation comprises visible radiation.

25. The method of claim 22, wherein the optical radiation comprises ultraviolet radiation.

26. The method of claim 22, wherein the composite material forms a flat lens.

27. The method of claim 22, wherein the composite material forms a superlens.

28. The method of claim 22, wherein the composite material forms a hyperlens.

29. The method of claim 22, wherein the metallic nanowires comprise at least one of gold, silver, aluminum and copper.

30. The method of claim 22, wherein the dielectric matrix comprises at least one of aluminum oxide and air.

31. The method of claim 22, wherein the optical radiation is directed at a substantially parallel orientation relative to the cylindrical axes of the nanowires.

32. The method of claim 22, wherein the optical radiation is directed at a substantially perpendicular orientation relative to the cylindrical axes of the nanowires.

33. A method of fabricating a metamaterial, comprising:
providing a matrix of a dielectric material; and
providing a plurality of metallic nanowires embedded in the matrix to form a composite material having a negative refraction property.

34. The method of claim 33, wherein the composite material is formed by a lithographic process.

35. The method of claim 33, wherein the composite material is formed by a self-assembly process.

36. The method of claim 33, further comprising:
providing a template of a dielectric material having a plurality of pores; and
filling the pores with a metallic material to embed the nanowires within the matrix.

37. The method of claim 36, wherein the porous template is formed by anodization.

38. The method of claim 36, wherein the pores are filled with metallic material by electrodeposition.

39. A metamaterial comprising:
a matrix of a dielectric material; and
a plurality of silicon carbide nanowires in the matrix to form a composite material, the composite material providing a negative refraction property.

40. The metalaterial of claim 39, wherein the composite material provides a negative refraction property at an mid-infrared frequency.

41. A metamaterial comprising:
a matrix of a dielectric material; and
a plurality of carbon nanotubes in the matrix to form a composite material, the composite material providing a negative refraction property.

42. The metamaterial of claim 41, wherein the composite material provides a negative refraction property at an infrared frequency.
